(19) United States
(12) Patent Application Publication
(10) Pub. No.: US 2008/0271980 A1
(43) Pub. Date: Nov. 6, 2008

(54) Production Method Of One Body Style Touch Pad And One Body Style Keypad Having Touch Pad Produced By That Method

(75) Inventor: Tae-Sik Seo, Seongnam-si (KR)

Correspondence Address: ROTHWELL, FIGG, ERNST & MANBECK, P.C., 1425 K STREET, N.W., SUITE 800, WASHINGTON, DC, 20005, US

(73) Assignee: SAMYOUNG TECHNOLOGIES CO., LTD., Seongnam-si, Gyeonggi-do (KR)

(21) Appl. No.: 11/721,886

(22) PCT Filed: Jan. 18, 2005
(86) PCT No.: PCT/KR05/00163

§ 371 Date: Jun. 27, 2007

(30) Foreign Application Priority Data
Dec. 15, 2004 (KR) 10-2004-0106314

(51) Int. Cl. H01H 21/00; H01H 11/00

(52) U.S. Cl. 200/293; 29/622

(57) ABSTRACT

The one body style keypad according to the present invention has the advantages that a keypad of ultra-thin dimensions is obtained, a visually high-quality presentation is realized due to the inherent luster of synthetic resin, and the manufacturing costs can be reduced because of low-cost synthetic resin unlike conventional keypads, since a key top, a base, and a front housing are formed into a self-contained single unit by the thin strip made of a synthetic resin member with respect to an one body style keypad according to the present invention.

### TECHNICAL FIELD

The present invention relates to keypads used in mobile phones, remote controllers and PDAs, and to be more specific, is related to a method for manufacturing ultra-thin touch pads formed of synthetic resin such as acrylic plastics that can be formed into a thin plate, and in which the base, a key top section and the front housing are configured so as be an one body style and an one body style keypad is designed to include the touch pad produced using the same method.

### BACKGROUND ART

Generally, keypads are mounted on mobile phones, remote control devices and PDAs, and are used as an input means for transmitting the user's input signal to a printed circuit board. For conventional keypads, a key top (10) and a base (20) arranged on the lower side of a front housing are connected through a connection section, like a keypad for a mobile phone, the cross section of which is shown in FIG. 8. The said key top (10) and a base (20) are connected to a front housing (40) to form the exterior appearance of a mobile phone. The said key top (10) has a structure that protrudes toward the outside of a hole formed on the front housing (40). The said key top (10) and a printed circuit board (PCB: 60) in which a dome switch (50) is mounted on the lower side of a base (20) are designed to be connected to a key top (10) with a predetermined space. On the lower side of the key top is formed a projection (11) to press the dome switch. A light source (70) is arranged in the backside of the key top in order to distinguish the characters or the diagrams printed outside of the key top (10) in darkened conditions.

An LED (light emitting diode) was used as a light source in the past, but recently, the use of thin-film EL (electro luminescence) lamp sheets has increased remarkably and these are characterized by the excellent uniformity of light. Power consumption is also minimal, and they are very advantageous for use in slim and lightweight products.

### DISCLOSURE OF INVENTION

### Technical Problem

Such conventional keypads have limitations in allowing the manufacture of slim, lightweight keypads since a dome switch and a light source are mounted on the PCB; a key top, a base, and a front housing are inter-connected with each other; and a PCB and a projection on the lower side of a key top are separated by a predetermined distance. In addition, conventional keypads has fundamental limitations in terms of forming a compact button section since the button section of the key top must be exposed to the hole of the front housing.

Therefore, the inventor of this present invention filed a patent application (the application NO.: 10-200400046477) and PCT application (the application NO.: PCT/KR2004/001807) with the Korean Intellectual Property Office after developing a metal key pad for mobile phones that realizes improvement of conventional problems.

But, as the need for satisfying the diverse tastes of consumers for products and the need for developing less costly keypads that can be applied to inexpensive products such as remote control devices and so on, as well as increasingly popular high-priced products such as mobile phones and PDAs, the applicant of the present invention suggested a self-contained, one body style keypad that is slim and lightweight as a result of its being forming of a touch pad made of synthetic resin having uniform restoring force and hardness, and by designing a base, a key top section and a front housing in a self-contained manner.

Furthermore, the present invention provides a keypad that is formed of synthetic resin such as ABS, or acrylic plastic or polycarbonate that is not used in conventional keypads in order to satisfy the diverse desires of consumers, and to reduce the manufacturing costs of keypads.

In addition, the present invention provides a keypad formed using visually high-quality synthetic resin that is produced through a predetermined step.

### Technical Solution

In order to achieve the aforementioned technical objectives, a keypad according to the present invention has a touch pad connected to a key top, a base and a front housing, a printed circuit board in which a fixed contact point is formed at a fixed position on the lower side of said touch pad, and a dome switch that is arranged on the upper side of said printed circuit board and is contacted to the fixed contact point on the printed circuit board due to the pressure of the touch pad, wherein the said touch pad comprises a thin strip that key top and front housing are self-contained in a single unit and the characters and other diagrams are printed on, and a resin pad connected to the lower side of the thin strip.

A thin strip according to the present invention is composed of synthetic resin such as acrylic plastic, polycarbonate or ABS.

A resin pad according to the present invention is formed of a resin film that is adhered to the lower side and the upper side around a plastic film and a projection allowing for easy contact with the dome switch is formed additionally on the lower resin film.

One of other characteristics of the present invention is that for the resin pad, the plastic film is formed by a PC film, and the resin film is formed by a silicon pad made of a silicon film.

Moreover, for the present invention's thin strip, a shape or a pattern is introduced by means of a metal press.

Other characteristics of the present invention are that a boundary line of embossed carving and depressed carving for identifying the button section on which the characters and diagrams are printed on the thin strip is formed.

Also, the present invention has a penetration line formed as a predetermined line type in some positions around each button of the button section so that the button sections are separated by a predetermined space by penetrating through the thin strip.

The present invention also has a metal sticker bearing the characters and diagrams that is adhered to the lower side of the thin strip.

Furthermore, the characters and diagrams of the present invention are printed on the upper side of the thin strip using a screen printing method.

The said thin strip has a thickness of 0.2 mm-0.6 mm.

The present invention provides the production method of the one body style touch pad, the method comprises the steps for:

(a) a thin processing step comprising a cutting step for cutting synthetic resin member into a thickness of 0.2-0.6 mm, and other suitable sizes, a printing step for the characters and diagrams on the cut synthetic resin member suitable for an object for which a keypad is used in the cutting step, and a checking step as a finishing touch to check for defects of the thin strip on which the characters and diagrams are printed on said synthetic resin member;

(b) a resin pad production step to produce a resin pad comprising a film printing step for printing diverse colors on a plastic film that is inserted into the middle section of the resin pad, a film cutting and perforating step for the plastic film on which the colors are printed according to the metal mold and a first forming step for depositing a resin film on the lower side of the film stably by a heat compression press, and forming the resin film, a second forming step for coating the resin film on the upper side of the firstly formed resin pad, a drilling step for drilling the outside section of the resin pad, the upper and lower side of which are processed, and a checking step to ensure the related specifications of the resin pad; and

(c) a bonding step of pressing and bonding the thin strip processed through the thin strip processing step, and the resin pad produced through the resin pad production step.

Other characteristics of the present invention are that said bonding step comprises a step for molding the penetration line for separating the button sections from each other, a step for attaching the adhesives or double-sided tapes on the lower side of the thin strip, and a step for bonding and pressing the resin pad on the lower side of the adhesives or double-sided tapes.

Another characteristic of the present invention is the production method of the one body style touch pad, the method comprises the steps for:

(a) a thin strip processing step comprising a cutting step for cutting synthetic resin member into a thickness of 0.2-0.6 mm, and other suitable sizes, and a printing step for printing the characters and diagrams on the cut synthetic resin member suitable for an object for which a keypad is used in the cutting step, and a checking step as a finishing touch and to ensure there are no defects on the thin strip on which the characters and the diagrams are printed on the synthetic resin member; and

(b) in-mold injection step comprising a film printing step for printing diverse colors on a plastic film that is inserted into the middle section of the resin pad, a cutting and perforating step for the plastic film on which the colors are printed according to the metal mold, a positioning step for the plastic film on the position separated by a pre-determined distance on the lower side of the thin strip, a filling step for the separated spaces by dropping the silicon resin into the space between the thin strip and plastic film, and the lower side of the plastic film, and a heat-pressure step for bonding and fixing the silicon resin on the lower side of the thin strip at the same time when depositing the silicon resin on the plastic film stably by applying heat-pressure by means of a metal mold.

Other characteristics of the present invention are that a cutting step further comprises a shape and pattern engraving step for engraving patterns and shapes on the upper or lower side of the thin strip cut in the cutting step by means of a metal press.

Other characteristics of the present invention are that it further comprises a boundary line forming step to form a boundary line of embossing or depression to distinguish the button section on the upper side of the thin strip by means of a metal press.

Other characteristics of the present invention are that it further comprises a penetration line forming step that separates the button sections with each other by penetrating through the thin strip, and which is formed as a predetermined line type in some positions around the button section.

Other characteristics of the present invention are that said printing step for printing the characters and diagrams includes a step for attaching a metal sticker bearing the characters or diagrams on the lower side of the thin strip.

Other characteristics of the present invention are that said printing step includes a screen printing step for printing the characters and diagrams on the upper side of the thin strip by means of a screen printing method.

### ADVANTAGEOUS EFFECTS

An one body style keypad according to the present invention provides the following benefits.

Since a touch pad is formed using a single unit thin plate made of a synthetic resin having a constant hardness and restoring force, there are benefits in that the thickness and weight are reduced remarkably when compared with conventional technology.

Furthermore, since the self-contained single unit type keypad according to the present invention is formed of various synthetic resin that is not used as a material in conventional keypads, there are additional benefits in that diverse consumer preferences are satisfied and the manufacturing costs for the keypad are reduced tremendously.

In addition, since various kinds of patterns or colors are engraved on the single unit keypad according to the present invention by means of a shape and pattern engraving or film printing step, there are benefits in that diverse exterior presentations of the keypad are realized and these can be visually high-quality and deluxe in appearance.

### BRIEF DESCRIPTION OF THE DRAWINGS

FIG. 1 is a plane diagram of one body style keypad according to the present invention.

FIG. 2 is a diagram of the cross section along A-A′ line of FIG. 1.

FIG. 3 is a cross-sectional diagram showing an one body style keypad according to the first embodiment of the present invention.

FIG. 4 is a plane diagram of the keypad on which a penetration line is formed, according to the present invention.

FIG. 5 is a procedure showing the first embodiment of the production method of one body style touch pad according to the present invention.

FIG. 6 is a cross-sectional diagram showing an one body style touch pad according to the second embodiment of the present invention in detail.

FIG. 7 is a procedure showing the second embodiment of the production method of one body style touch pad according to the present invention.

FIG. 8 is a cross-sectional diagram showing a conventional keypad.

### MODE FOR THE INVENTION

Below, one embodiment in which an one body style keypad according to the present invention is applied to a keypad for a mobile phone will be explained in detail by referring to the attached drawings.

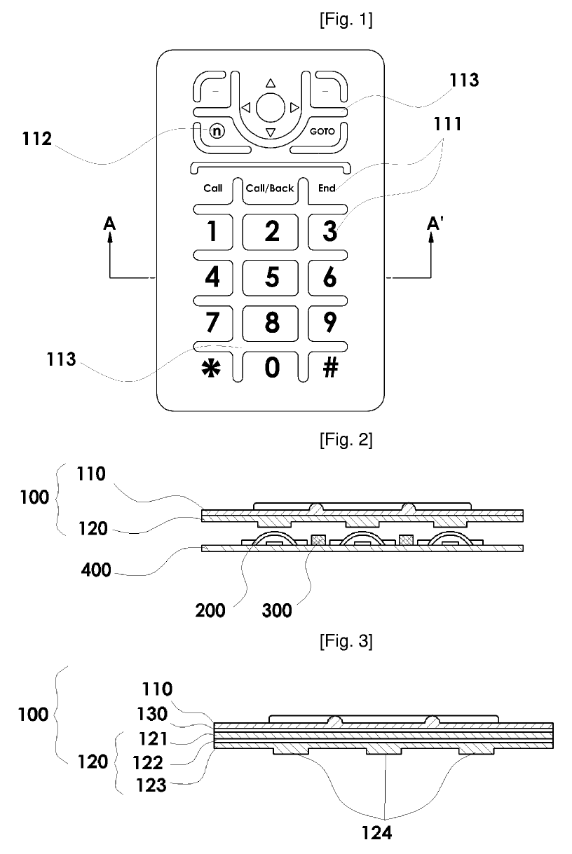

As shown in FIGS. 1 and 2, an one body style keypad according to the present invention is composed of a thin touch pad (100) in which a key top, a base and a front housing are connected as one body, a printed circuit board (PCB: 400) onto which a fixed contact point is formed at a fixed position on the lower side of the touch pad (100), and a dome switch (200) which is arranged on the upper side of said printed circuit board and is contacted to the fixed contact point on printed circuit board due to the pressure of a touch pad (100).

Furthermore, it is natural that a light source such as an LED (300) or an EL may be arranged between said touch pad (100) and PCB (400) in case that there are demands for visually high-class products required for the keypads of mobile phones, and for enhancing convenience during the night use.

The said touch pad (100) is composed of a thin strip (110) including synthetic resin on which the characters and diagrams are printed, and a resin pad (120) connected to the lower side of the thin strip (110) for a buffer function when contacting a dome switch (200).

At this time, said thin strip (110) is formed of synthetic resin having a thickness of 0.2 mm-0.6 mm, and it is preferable that the thin strip (110) having a thickness of approximately 0.4 mm be formed so that predetermined durability may be maintained and a slim keypad is realized.

In connection with said synthetic resin member, a key top section that is divided into a boundary line and a penetration line moves by a predetermined distance toward the operation direction of an external force and contacts with a dome switch. The said synthetic resin member consists of synthetic resin or ceramic having a restoring force for restoration to the original state when the external force is removed, and a pre-determined hardness to prevent the thin strip from being damaged due to the external force which presses the key top from outside.

At this time, said synthetic resin is polymerized from an ester, and has characteristics such as excellent transparency, and lightness of weight. And it is an acrylic plastic that is superior in terms of processing. But it is more preferable that said synthetic resin is formed of polycarbonate, or Acrylonitrile, Butadiene, or Styrene, which are superior in terms of shock-proofing, heat-proofing, and dimensional stability of the molding products because of transparency and hardness, and it is preferable that the ABS resin have good elasticity, hardness and dimensional stability is employed to constitute the synthetic resin.

Patterns or figures such as hairline shapes are engraved on the lower side of the thin strip (110) by a press engraving method using a metal press. Since said thin strip (110) is transparent or semi-transparent because of the properties of the materials used, the engraved hairline patterns can be seen from the upper side of the thin strip (110), and thereby, a visually high-quality presentation is realized. Such hairline patterns can be engraved on the upper side of the thin strip (110), and spin patterns can also be printed.

On the other hand, it is preferable that a boundary line formed by embossed carving and depressed carving by means of a metal press for identifying the button section on which the characters (111) and diagrams (112) are printed is formed.

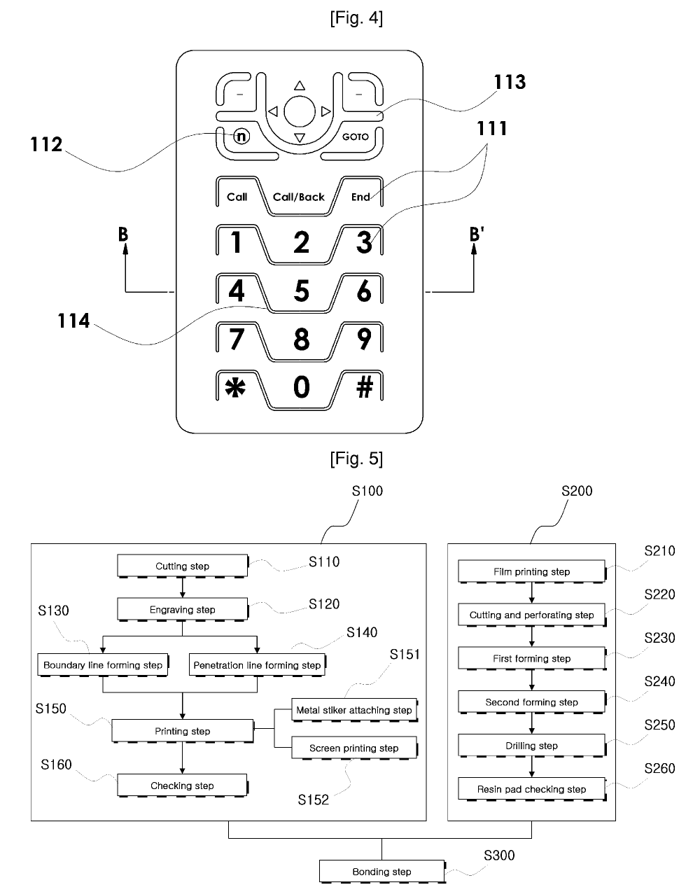

At this time, without forming a boundary line on the thin strip (110), as shown in FIG. 4., a penetration line can be formed as a predetermined line type in some positions around each button of the button section while separating the button sections by a predetermined distance by penetrating through the thin strip, so that the button section of the thin strip (110) on which the characters (111) and diagrams (12) are printed may move in an upper or lower direction independently, and may press the dome switch positioned on the lower side of the thin strip (110).

Furthermore, the characters and diagrams formed on the thin strip (110) are formed by a method of attaching a metal sticker bearing the characters and diagrams on the lower side of the thin strip (110), or the characters and diagrams are formed on the upper side of the thin strip (110) by means of a screen printing method. In case that the characters and diagrams are formed by a method of attaching a metal sticker, it is possible to see the characters and the diagrams formed on a metal sticker from the upper side of the transparent or semi-transparent thin strip (110). And, the screen printing method can be performed according to the widely known procedures including the decision of the number of screen prints according to the colors, film preparation step, the step for producing screen printing block, the engraving step, and the printing and finishing steps.

The said resin pad (120) is composed of a resin pad that is adhered to the lower and upper sides around a plastic film, and a projection (124) formed on the lower resin film for making contact with a dome switch (200), as shown in FIG. 3.

At this time, it is preferable that said resin pad consist of a silicon pad (120), wherein the resin film is formed of a silicon film (123, 124) made from a silicon resin, and the plastic film is formed of a PC film (Polycarbonate film)(122).

Furthermore, various colors can be printed on the PC film (122), and the silicon film (121, 123) and PC film (122) are bonded by a press compression and bonding method using a heat pressure press. After the silicon film (121, 123) and PC film (122) are bonded as such, the lower and upper silicon film (121, 123) are subject to the molding step by which they are molded into predetermined shapes according to the molding structures of the thin strip (110).

The thin strip (110) and the silicon pad (120) formed in this way are bonded by various means such as double-sided tapes provided on the joining surface or by means of compression of other adhesives, and thereby, the one body style touch pad (100) is formed.

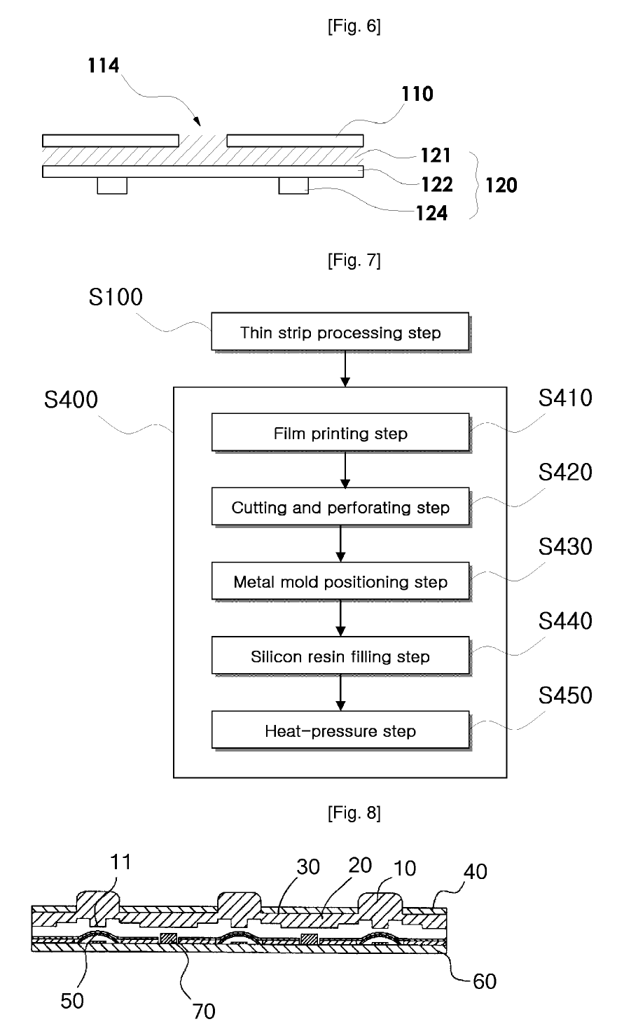

At this time, as shown in FIG. 6, the thin strip and silicon pad can be bonded and then formed by in-mold injection, which inserts the PC film of the silicon pad (120) into the metal mold, heat-bonds a silicon pad (120) to the thin strip (110) at the same time when coating the PC film with resin film by dropping silicon resin, and bonds the thin strip and the resin pad solidly as the silicon resin filled between the penetration line formed on the thin strip is hardened.

In addition, the one body style keypad is formed since a printed circuit board (PCB) on which a dome switch (200) and a light source, LED (300) are mounted is arranged on the lower side of the touch pad (100), as with conventional technology.

Next, the first embodiment of the method for manufacturing the one body style touch pad constituting an one body style keypad according to the present invention will be explained.

As shown in FIG. 5, the one body style touch pad (110) is manufactured by a thin strip step (S100) for forming a thin strip constituting the upper side of the one body style keypad, in which a key top provided with a button section on which the characters and diagrams are printed, a base on which diverse patterns and shapes are engraved, and a front housing are connected into a single unit, a resin pad production step (S200) for forming a resin pad bonded to the lower side of the thin strip for a buffer function when contacting with a dome switch, and a bonding step (S300) of bonding the thin strip and the resin pad.

The thin strip processing step (S100) consists of a cutting step (S110) whereby a synthetic resin member is cut into a thickness of 0.2-0.6 mm, or other suitable sizes, a printing step (S150) for printing the characters and diagrams on the cut synthetic resin member suitable for an object for which a keypad is used in said cutting step (S110), and a checking step (S160) as a method of inspecting for defects of the thin strip on which the characters and diagrams are printed on said synthetic resin member.

At this time, it is preferable that an engraving step (S120) for engraving patterns and shapes on the upper or lower sides of the synthetic resin member be means of a metal press after cutting the synthetic resin member into suitable thickness and size is included additionally.

Furthermore, it is preferable that a boundary line forming step (S130) for forming a boundary line of embossing or depression for distinguishing the button section on the upper side of the synthetic resin member by means of a metal press be utilized.

Furthermore, it is preferable that after engraving diverse shapes or patterns on the synthetic resin member in the engraving step (S120) without forming a boundary line on the synthetic resin member, a penetration line forming step (S140) for forming a penetration line (114) that separates the button sections from each other by penetrating through the synthetic resin member is included, wherein the button section of the synthetic resin member on which the characters and diagrams are printed is formed as a predetermined line type in some positions around the button section, so that it may move independently in an upper or lower direction in the printing step (S150).

The printing step (S150) is a step for forming a thin strip (110) of a touch pad by printing the characters or diagrams on the synthetic resin member which is cut in the cutting step (S110), or on which the patterns are engraved in the engraving step (S120), or a penetration line or a boundary line is formed in said step (S130) or said step (S140). The printing step (S150) is composed of a metal sticker attaching step (S151) for attaching a metal sticker bearing the characters or diagrams on the lower side of the thin strip (110), or a screen printing step (S152) for printing the characters or diagrams on the upper side of the thin strip (110) by means of a screen printing method.

At this time, the screen printing step (S152) consists of a step for deciding the number of screen prints according to the colors, a film preparation step, a step for producing screen printing block, an engraving step, a printing step, and a finishing step, which are already widely known processes.

At this time, the step (S151) for attaching a metal sticker and the step (S152) for printing the characters or diagrams can be applied selectively in order to print the characters or diagrams on the thin strip (110).

The resin pad production step (S200) is composed of a film printing step (S210) for printing diverse colors on a plastic film (122) inserted into the middle section of a resin pad (120), a cutting and perforating step (S220) for cutting the plastic film (122) according to the metal mold, and perforating a hole, a first forming step (S230) for depositing a resin film on the lower side of a film stably by a heat compression press, and forming the resin film, a second forming step (S240) for coating a resin film (121) on the upper side of the firstly formed resin pad, a drilling step (S250) for drilling the outside section of the resin pad, the upper and lower sides of which are processed, and a resin pad checking step (S260) for checking the related specifications of a resin pad.

At this time, it is preferable that the resin film be composed of a silicon film (121, 123) formed by silicon resin, and that the plastic film be composed of PC film (122).

The bonding step (S300) includes the compression and bonding of the thin strip (110) processed through the thin strip processing step (S100), and the resin pad (120) produced through the resin pad production step (S200) by using the adhesives or double-sided tapes.

At this time, in case that a penetration line is formed on the thin strip in the thin strip processing step (S100), the bonding step (S300) comprises a step (S310) for molding the penetration line (114) for separating the button sections from each other, a step (S320) for attaching the adhesives or double-sided tapes on the lower side of the thin strip (110), and a step (S330) for bonding and pressing the resin pad (120) on the lower side of the adhesives or double-sided tapes.

After the thin strip (110) and the resin pad (120) are bonded firmly so that the one body style touch pad (100) is formed in the bonding step (S300), a printed circuit board (400) provided with a dome switch (200) and LED (300) on the lower side of the one body style touch pad (100) is arranged, and thereby, the keypad is formed.

Next, the second embodiment of the method for manufacturing an one body style touch pad constituting a single unit keypad according to the present invention will be explained.

As shown in FIG. 7, the one body style touch pad (110) is composed of a thin strip process step (S100) for forming a thin strip constituting the upper side of the single unit keypad, on which a key top, a base, and a front housing are connected in a self-contained manner, and in-mold injection step (S400) for injecting a resin pad to the lower side and bonding.

Like the first embodiment, the thin strip processing step (S100) includes a step for cutting synthetic resin member into a thickness of 0.2-0.6 mm, and other suitable sizes, a printing step for printing the characters and diagrams on the cut synthetic resin member, a checking step to inspect for defects of a thin strip, a step for engraving the patterns on the thin strip, and a step for forming a boundary line or a penetration line, thereby the thin strip constituting the upper side of the self-contained single unit touch pad is formed.

The in-mold injection step (S400) is a step for simplifying the resin pad production step (S200) and the bonding step (S300) of the first embodiment into one process, and is composed of a film printing step (S410) for printing diverse colors on a plastic film (122) positioned in the middle section of a resin pad, a cutting and perforating step (S420) for cutting the plastic film (122) on which the colors are printed according to the metal mold, and perforating a hole, a metal mold positioning step (S430) for positioning the plastic film (122) on the position separated by a predetermined distance on the lower side of the thin strip (110), a silicon resin filling step (S440) for filling the separated spaces by dropping the silicon resin into the space between the thin strip and plastic film, and the lower side of the plastic film, and a heat-pressure step (S450) for bonding and fixing the silicon resin on the lower side of the thin strip by the hardening process of the silicon resin at the same time when depositing the silicon resin on the front and back sides stably by heat-pressure after the silicon resin is filled.

If the silicon resin is filled into the space between the thin strip and the plastic film, since the filled silicon resin is introduced to even the penetration line for separating the button section of the thin strip from each other and hardened, the additional molding process is not necessary, and thereby the entire process is simplified.

Then, a printed circuit board (400) provided with a dome switch (200) and an LED (300) on the lower side of the one body style touch pad (100) is arranged, and thereby the single unit keypad is formed.

The one body style keypad according to the present invention is characterized in that it reduces manufacturing costs and makes it possible to produce diverse products by using ceramic, or synthetic resin ceramic such as ABS, acrylic plastic or polycarbonate that is not used in conventional keypads, the resulting product is thinner than conventional keypads by making a key top, a base and a front housing in a self-contained single unit manner, using a touch pad having ultra-thin dimensions, in addition, shock-proofing is improved when contacting a dome switch by bonding a resin pad to the lower side of the thin strip, and the button section is identified by forming a boundary line on the upper side of the thin strip.

It is understood that it is possible to replace, and change the above-mentioned characteristics, based upon the technology level published when the application was filed, and replacements and changes are made within the scope of the invention.

1. An one body style keypad having a touch pad connected to a key top, a base and a front housing, a printed circuit board in which a fixed contact point is formed at a fixed position on the lower side of the touch pad, and a dome switch that is arranged on the upper side of the printed circuit board and is contacted to the fixed contact point on the printed circuit board due to the pressure of the touch pad, wherein the touch pad comprises:
(a) a thin strip that key top and front housing formed in a single unit and the characters and other diagrams are printed on; and
(b) a resin pad connected to the lower side of the thin strip.

2. The one body style key pad of claim 1, wherein said thin strip is composed of synthetic resin such as acrylic plastic, polycarbonate or ABS.

3. The one body style key pad of claim 1, wherein said resin pad is formed of a resin film that is adhered to the lower side and the upper side around a plastic film and a projection allowing for easy contact with the dome switch is formed additionally on the lower resin film.

4. The one body style key pad of claim 3, wherein said resin pad comprises a plastic film formed by a PC film, and a resin film formed by a silicon pad made of a silicon film.

5. The one body style key pad as in claim 1, wherein said thin strip having a shape or a pattern introduced by means of a metal press.

6. The one body style key pad as in claim 1, wherein a boundary line of embossed carving and depressed carving for identifying the button section on which the characters and diagrams are printed on the thin strip is formed.

7. The one body style key pad as in claim 1, wherein a penetration line formed as a predetermined line type in some positions around each button of a button section so that the button sections are separated by a predetermined space by penetrating through the thin strip.

8. The one body style key pad as in claim 1, wherein a metal sticker includes the characters and diagrams that is adhered to the lower side of the thin strip.

9. The one body style key pad as in claim 1, wherein characters and diagrams are printed on the upper side of the thin strip using a screen printing method.

10. The one body style key pad as in claim 1, wherein said thin strip has a thickness of 0.2 mm-0.6 mm.

11. The production method of an one body style touch pad, the method comprising the steps for:
(a) a thin strip processing step comprising a cutting step for cutting synthetic resin member into a thickness of 0.2-0.6 mm, and other suitable sizes, a printing step for the characters and diagrams on the cut synthetic resin member suitable for an object for which a keypad is used in the cutting step, and a checking step as a finishing touch to check for defects of the thin strip on which the characters and diagrams are printed on synthetic resin member;
(b) a resin pad production step comprising a film printing step for printing diverse colors on a plastic film that is inserted into the middle section of the resin pad, a film cutting and perforating step for the plastic film on which the colors are printed according to the metal mold, a first forming step for depositing a resin film on the lower side of the film stably by a heat compression press, and forming the resin film, a second forming step for coating the resin film on the upper side of the firstly formed resin pad, a drilling step for drilling the outside section of the resin pad, the upper and lower side of which are processed, and a checking step to ensure the related specifications of the resin pad; and
(c) a bonding step of pressing and bonding the thin strip processed through the thin strip processing step, and the resin pad produced through the resin pad production step.

12. The production method of the one body style touch pad of claim 11, wherein said bonding step comprises a step for molding the penetration line for separating the button sections from each other, a step for attaching the adhesives or double-sided tapes on the lower side of the thin strip, and a step for bonding and pressing the resin pad on the lower side of the adhesives or double-sided tapes.

13. The production method of an one body style touch pad, the method comprising the steps for:
(a) a thin strip processing step comprising a cutting step for cutting synthetic resin member into a thickness of 0.2-0.6 mm, and other suitable sizes, and a printing step for printing the characters and diagrams on the cut synthetic resin member suitable for an object for which a keypad is used in the cutting step, and a checking step as a finishing touch and to ensure there are no defects on the thin strip on which the characters and the diagrams are printed on the synthetic resin member; and
(b) in-mold injection step comprising a film printing step for printing diverse colors on a plastic film that is inserted into the middle section of the resin pad, a cutting and perforating step for the plastic film on which the colors are printed according to the metal mold, a positioning step for the plastic film on the position separated by a predetermined distance on the lower side of the thin strip, a filling step for the separated spaces by dropping the silicon resin into the space between the thin strip and plastic film, and the lower side of the plastic film, and a heat-pressure step for bonding and fixing silicon resin on the lower side of the thin strip at the same time when depositing silicon resin on the plastic film stably by applying heat-pressure by means of a metal mold.

14. The production method of the one body style touch pad as in claim 11, wherein said cutting step further comprises a shape and pattern engraving step for engraving patterns and shapes on the upper or lower side of the thin strip cut in the cutting step by means of a metal press.

15. The production method of the one body style touch pad as in claim 11, further comprising a boundary line forming step to form a boundary line of embossing or depression to distinguish the button section on the upper side of the thin strip by means of a metal press.

16. The production method of the one body style touch pad as in claim 11, further comprising a penetration line forming step that separates button sections with each other by penetrating through the thin strip, and which is formed as a predetermined line type in some positions around the button section.

17. The production method of the one body style touch pad as in claim 11, wherein said printing step for printing the characters and diagrams is a step for attaching a metal sticker bearing the characters or diagrams on the lower side of the thin strip.

18. The production method of the one body style touch pad as in claim 11, wherein said printing step for printing the characters and diagrams is a screen printing step for printing the characters and diagrams on the upper side of the thin strip by means of a screen printing method.
